(19) United States
(12) Patent Application Publication
(10) Pub. No.: US 2016/0256806 A1
(43) Pub. Date: Sep. 8, 2016

(54) COMPOSITE FILTER MEDIA INCLUDING A NANOFIBER LAYER FORMED DIRECTLY ONTO A CONDUCTIVE LAYER

(71) Applicant: LYDALL, INC., Manchester, CT (US)

(72) Inventors: Robert G. Sanders, Rochester, NH (US); Stephen Edward Gross, Dover, NH (US); Timothy Scott Lintz, Waterford, NY (US)

(73) Assignee: LYDALL, INC., Manchester, CT (US)

(21) Appl. No.: 15/059,781

(22) Filed: Mar. 3, 2016

Related U.S. Application Data
(60) Provisional application No. 62/129,612, filed on Mar. 6, 2015.

(51) Int. Cl. B01D 39/16; D01D 5/00

(52) U.S. Cl. CPC B01D 39/1623; D01D 5/0007

(57) ABSTRACT

A composite filter media of a nanofiber layer that includes nanofibers formed from non-polar, non-conductive thermoplastic polymers using a solution spinning process to form the nanofibers directly onto a conductive layer is presented, along with the associated methodology for making such media. The conductive layer includes at least about greater than about 5 wt. % conductive fibers, Z-directional conductivity and a uniform surface conductivity of at least about 10⁻⁷ microsiemens.

### CROSS-REFERENCE TO RELATED APPLICATIONS

This application claims benefit of U.S. Provisional Application No. 62/129,612 filed Mar. 6, 2015, which is incorporated herein by reference in its entirety.

### FIELD

A composite filter media for removing particulates from a fluid is generally described. In particular, the composite filter media includes a nanofiber layer formed directly onto a conductive layer.

### BACKGROUND

Webs of very fine fibers, that is, fibers having a diameter of less than about 1 micron (1000 nanometers), are well known in the art to make highly efficient air filtration media. One known method to form such “nanofibers” is to use an electrostatic discharging process on streams of polymer solutions, often referred to as electrospinning. While higher loadings of nanofibers tend to result in higher efficiency media, charges built up in the collected fiber web can result in limitations on how much fiber can be collected in this manner, thus limiting the range of possible filtration efficiencies.

In particular, typical electrospinning processes spin the nanofibers or sprays them as droplets by applying high electrostatic fields to one or more fluid-filled spraying or spinning tips (i.e., nozzles or spinnerets). The high electrostatic field typically (at least when using a relatively conductive fluid) produces a Taylor cone at each tip opening from which fibers or droplets are ejected. The sprayed droplets or spun fibers may be collected on a target substrate or onto screen. A high voltage supply provides an electrostatic potential difference (and hence the electrostatic field) between the spinning tip (usually at high voltage) and the target substrate (usually grounded). A number of reviews of electrospinning have been published, including (i) Huang et al., “A review on polymer nanofibers by electrospinning and their applications in nanocomposites,” Composites Science and Technology, Vol. 63, pp. 2223-2253 (2003), (ii) Li et al., “Electrospinning of nanofibers: reinventing the wheel?”, Advanced Materials, Vol. 16, pp. 1151-1170 (2004), (iii) Subbiath et al., “Electrospinning of nanofibers,” Journal of Applied Polymer Science, Vol. 96, pp. 557-569 (2005), and (iv) Bailey, Electrostatic Spraying of Liquids (John Wiley & Sons, New York, 1988). Details of conventional electrospinning materials and methods can be found in the preceding references and various other works cited therein.

Thus, although compositions utilizing nanofibers have been around for many years, creating useful filtration media with such small fibers has proven challenging. In addition, since it is difficult to make self-supporting nanofiber layers or at least to handle such nanofiber layers without damaging them, forming such nanofiber layers upon the support layer, has been attempted and also proven challenging. In fact, creating such nanofiber layers upon a target substrate or support layer with a basis weight greater than about 0.35 gsm has not been particularly successful.

In view of the disadvantages associated with currently available nanofiber layers and methods of making them, there is a need for a media including a nanofiber layer having a greater basis weight than those previously made available, particularly while maintaining high efficiency ratings for removal of ultrafine particles and also appropriate permeability and physical attributes (i.e., pleatibility, stiffness, etc.) of the media.

### BRIEF DESCRIPTION

According to an aspect, a composite filter media of a nanofiber layer that includes nanofibers formed from non-polar, non-conductive thermoplastic polymers using a solution spinning process to form the nanofibers directly onto a conductive layer is presented, along with the associated methodology for making such media. The conductive layer includes at least about greater than about 5 wt. % conductive fibers, Z-directional conductivity and a uniform surface conductivity of at least about 10⁻⁷ microsiemens.

### BRIEF DESCRIPTION OF THE FIGURES

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1 is a highly stylized cross-sectional view of a composite filter media according to an embodiment;

FIG. 2 is a highly stylized cross-sectional view of a composite filter media according to an embodiment; and

FIG. 3 is a schematic representation of a typical process wherein the solution spun nanofiber layer is formed directly onto the conductive layer.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

### DEFINITIONS

Air filter—a device for removing particulate matter from an airstream including a mixture of gases and particulate matter.

Alpha—Filter media can be rated according a value termed “alpha value,” also called gamma value or quality factor or figure of merit. Steeper slopes, or higher alpha values, are indicative of better filter performance. Alpha value is expressed according to the following formula: alpha=(−log(DOP penetration %/100)/pressure drop in mm H₂O)×100

ASHRAE—American Society of Heating, Refrigeration, and Air-Conditioning Engineers.

ASHRAE 52.2—The ASHRAE testing method for air filters that classifies filters according to minimum performance data (the version in common use as of the date of filing of this application). Results of ASHRAE 52.2 are expressed as Minimum Efficiency Reporting Value (MERV) ratings. This is widely considered to be the best method for assessing filtration performance as it is based upon minimum performance not average performance (as is the case for ASHRAE 52.1 and EN779).

Basis weight—The basis weight of a nonwoven material, such as a wet-laid, dual layer filtration media, is usually expressed in weight per unit area, for example in grams per square meter (gsm) or ounces per square foot (osf) (1 osf=305 gsm) or lbs./3000 ft² and as measured according to T.A.P.P.I.—T-410, A.S.T.M.—D-646.

Fiber—a material form characterized by an extremely high ratio of length to diameter. As used herein, the terms fiber and filament are used interchangeably unless otherwise specifically indicated.

Filter media—the material used in a filter that makes up the filter element.

Frazier—The rate of airflow through a material under a constant differential pressure between the two media surfaces. The rate is measured generally in accordance with ASTM D737-75. Units are cubic feet per square foot of sample per minute—reported as (cfm) (differential pressure is 0.5 inches water gauge (WG) (124.5 Pascal). (Also known as permeability.)

HEPA—High Efficiency Particulate Air filter. A HEPA filter must achieve a minimum efficiency of 99.97% on 0.3 micron particles to be called a HEPA as per ASHRAE standards.

MERV—Acronym for Minimum Efficiency Reporting Value—obtained from full ASHRAE 52.2 1999 test report. The number is obtained by comparison of test data to a MERV Chart. (See, Table 1 below, which is an excerpt from the MERV Chart.)

Micron (micrometer)—one millionth of a meter (μm). Equal to 1/25,400th of an inch.

Penetration(%)=C/C₀, where C is the particle concentration after passage through the filter and C₀ is the particle concentration before passage through the filter. Penetration can be measured according to the U.S. Military Standard MIL-STD-282 (1956). Typical tests of penetration involve blowing dioctyl phthalate (DOP), or dioctyl sebacate (DEHS), an accepted equivalent to DOP, particles through a filter media and measuring the percentage of particles that penetrate through the filter media. The DOP or DEHS aerosol particles are approximately 0.3 microns in diameter and blown at a face velocity of approximately 5.3 cm/sec through the filter media.

Resistance—is a measure of the pressure drop across the filter media when tested according to MIL-STD-282, A.S.T.M.—D2986-91. In essences, a flat sheet (100 cm²) is subjected to an airflow stream of about 8 cm/s flow rate and a pressure drop across the filter is measured. As reported in Table 2 hereinbelow, the Resistance was reported in three different levels: 1. BHT—as tested by an independent lab, 2. 8130—using a TSI 8130 machine and 3. 8127—using a TSI 8127 machine.

Stiffness—is a measure of cantilever bending of the fabric under its own weight measured using a Gurley Stiffness Tester according to ASTM D5732.

Synthetic polymeric fiber—is a fiber comprising, synthetic, non-natural fibers made from synthetic, non-natural polymers.

Thickness—is determined according to Technical Association of the Pulp and Paper Industry (TAPPI) T 411 om-89, “Thickness (caliper) of paper, paperboard, and combined board” using an electronic caliper microgauge 3.3 Model No. 49-62 manufactured by TMI with a foot pressure of 8 psi.

### DETAILED DESCRIPTION

Reference will now be made in detail to various embodiments. Each example is provided by way of explanation, and is not meant as a limitation and does not constitute a definition of all possible embodiments.

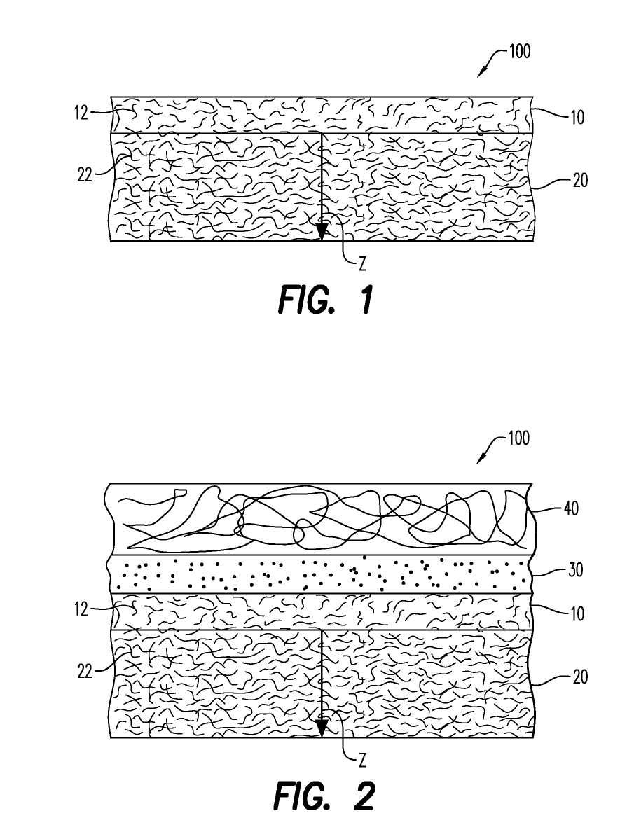

For purposes of illustrating features of the embodiments, a simple example will now be introduced and referenced throughout the disclosure. Those skilled in the art will recognize that this example is illustrative and not limiting and is provided purely for explanatory purposes. In the illustrative example and as seen in FIGS. 1 and 2, a composite filter media 100 for removing particulates from a fluid is generally depicted. In particular, the composite filter media 100 includes at least a nanofiber layer 10 formed directly onto a conductive layer 20.

The novel composite filter media and methods described herein provide a means for achieving extremely favorable efficiency ratings, particularly in applications where the media is required to be discharged. Such media may exhibit high efficiency reporting values of MERV 14-16 when evaluated under ASHRAE 52.2, particularly when discharged according to Appendix J of the same standard. In short, the conductive layer provides a collection support sufficient to create useful filtration media with appropriate permeability and physical attributes (i.e., pleatability, stiffness, etc.), while also serving to dissipate the charge buildup in the collected nanofibers, allowing for much higher loadings (increased basis weight) to be captured in the filtration composite. Other applicable standards include, but are not limited to EN 779-2012.

Turning specifically to FIG. 1, a two-layer composite 100 is depicted in a highly stylized cross-sectional view according to an embodiment. In this embodiment, the conductive layer 20 is a porous, wetlaid nonwoven material, and the nanofiber layer 10 has been formed directly onto the conductive layer 20, as described in greater detail hereinbelow. Methods of making wetlaid nonwoven materials is well known by those of ordinary skill in the art, and will not be discussed in detail herein. An important feature of conductive layer 20 of the composite filter media 100 as disclosed herein is that the conductive layer 20 must include at least a portion of conductive fibers 22.

It was found that forming the nanofiber layer 10 directly onto the conductive layer 20 was critical to being able to form the nanofiber layer 10 having a heavy loading, e.g. at a basis weight of about 0.5-2.0 gsm. In fact, it was found that non-conductive layers allowed accumulation of voltage potential (formed in the nanofiber-forming process as described below—the solution spun process), which eventually repelled the fiber deposition onto the non-conductive layers, and thus forming a nanofiber layer 10 having a basis weight of at least about 0.5 gsm was not possible. In an embodiment the nanofiber layer has a basis weight of greater than about 0.6 to about 2.0 gsm.

The conductive fibers 22 useful in forming the conductive layer 20 according to an embodiment are conductive fibers including but not limited to metal fibers, ionomer fibers, metal- or ionomer-coated fibers, carbon fibers, graphite fibers, or combinations thereof. While it is possible that conductive particles, (that is, particles having a length of less than about 6 mm), may be used in the conductive layer 20 described herein, the conductive layer 20 must have conductive fibers 22, arranged in the Z-direction, as described in further detail hereinbelow, in order to achieve the desirable filtration properties. In addition, the conductive layer 20 must include sufficient conductive fibers 22 to achieve a uniform surface conductivity of at least about 10⁻⁷ microsiemens. Methods for measuring surface conductivity are well known by those having ordinary skill in the art, and as found, for instance, in ASTM B 193-87. In an embodiment, the wetlaid nonwoven conductive layer is made entirely from conductive fibers 22, while in other embodiments, the conductive layer is made from a blend of conductive fibers 22 and synthetic fibers 24. The conductive layer 20 includes at least greater than about 5 wt. % conductive fibers 22, or at least about 7 wt. % conductive fibers, or at least about 10 wt. %, or more.

As describe above, the conductive layer 20 may also include synthetic fibers 24, that is, fibers made from synthetic polymeric resins. Examples of such useful polymers include but are not limited to one or more of polyester, nylon, acrylic, modacrylic, and polyolefin. More specifically, the synthetic polymeric fiber may be made from the following polymers: polylactide (PLA), polyethylene, polypropylene, polyethylene terephthalate (PET), aliphatic polyamides (Nylon), and/or polybutylene terephthalate (PBT). It is also contemplated that the conductive layer 20 may include other additives and/or natural fibers, such as glass, cotton, cellulose, and the like.

The fibers (conductive and/or synthetic fibers) are mixed into a matrix to form the conductive layer 20, the conductive layer having Z-directional conductivity. In other words, the conductive layer 20 is made such that many of the conductive fibers 22 are formed or placed into the nonwoven matrix in the Z-direction as depicted in FIGS. 1 and 2 and indicated by arrow Z. The fibers 22 are essentially standing on end, and thus form electrical conduits or pathways through the matrix, which assists in maintaining the electrical field to accommodate the solution spun process described below, and allows for heavier deposition of the nanofiber layer 10 upon the conductive layer 20.

In addition to having a surface conductivity of at least about 10⁻⁷ microsiemens, the conductive layer 20 may also have the following properties: a basis weight of about 10-200 grams per square meter (gsm), a thickness of about 13 to 16 mils (unit of length equal to 1/1000 inch), a stiffness of about 500 to 900 mg, an alpha of about 14.8 (determined as an average of 15 samples), and a Frazier of about 200-1000 cubic feet per minute (cfm). According to an aspect, the conductive layer 20 is self-supporting and is pleatable. That is, it is capable of being formed into a pleat, as is typically necessary for filtration materials, without compromising the integrity of the filtration material. Without wishing to be bound by theory, it is believed that the surface conductivity of at least about 10⁻⁷ microsiemens and the Z-directional conductivity are achieved through an optimal amount of conductive fibers in the conductive layer 20. It was found that loadings of at least about 3 wt. % conductive fiber in the conductive layer 20 were not sufficient to achieve the required surface and Z-directional conductivity.

While the nonwoven web forming the conductive layer 20 can be a felted, airlaid or wetlaid web, a wet-laid nonwoven material has proven most useful. Thus, the conductive fibers 22 are capable of being arranged to form Z-directional conductivity. When a web is laid in a wet process, i.e. on a conventional paper-making machine, the fibers of the web are largely oriented in the plane of a porous surface against which the web is laid, that is, in the X-Y-direction. That generally lateral orientation of the fibers provides considerable strength to the web in that lateral direction. Strength in the transverse direction, or Z-direction has not traditionally been viewed as important as strength in the lateral direction, since, when applying a coating to the web, the web is pulled in the lateral direction. In addition, when the web is a wetlaid web, as noted above, a water soluble binder can be added to the water dispersion for forming the wetlaid web, if desired, although such introduction of binder, while very convenient, is not required.

The highly conductive “Z” direction design of the conductive layer 20 essentially creates “electrical conduits” which provide dissipation of the implied high voltage and highly ionized air created during the nanofiber forming process (described in greater detail hereinbelow), through the conductive layer 20 to earthen ground. It also wicks away implied voltage and ionized surface energy, minimizing the buildup which occurs in the nanofibers themselves to allow high deposition basis weights (greater than or equal to about 0.5 gsm up to about 2.0 gsm). This threshold for conductivity is measured using a surface conductivity meter and has a minimal value of 10⁻⁷ microsiemens in standard atmospheric conditions (72 F @ 50% RH). Additional conductivity can be achieved by adding additional carbon fibers or higher levels of atmospheric humidity to create additional and/or enhanced “Z” direction dissipation.

As would be understood by one of ordinary skill in the art of making wetlaid structures, there will always be a certain amount of Z-directional fibers formed naturally in the material. What was recognized as a key feature for the embodiments described herein, however, is that a certain amount of Z-directional conductivity was required to achieve the desired nanofiber loadings on top of the conductive layer. According to an embodiment, it is believed that at least about 7 wt. % conductive fibers are required to get the proper Z-directional conductivity to form the composite filter media described herein. In fact, additional loading of conductive fibers may detract from the structural integrity of the conductive layer and/or impart greater costs to manufacturing the conductive layer than are necessary to achieve the desired effect. One method for forming or laying at least some of the conductive fibers in the Z-direction includes enhanced viscosity modification in the paper machine headbox via continuous Nalco 625 (synthetic sodium polyacrylate) addition to the dilution water. This in turn allows for the larger synthetic polymeric resin fibers to migrate to the paper machine forming fabric faster and begin to form the conductive layer 20 first. Subsequently, the smaller conductive fibers stay in suspension longer and end up getting predominantly trapped in the Z-direction as the sheet continues to form.

Another key feature described herein has to do with the ability to form the nanofiber layer 10 directly upon or onto the conductive layer 20. Thus, it is unnecessary to provide an adhesive or mechanical attachment mechanism between the conductive layer 20 and the nanofiber layer 10 to form the multi-layered composite filtration media 100.

In an embodiment, the nanofiber layer 10 is made using a modified electrospinning process, that is, a process that dissolves a thermoplastic polymer in a solution, and electrospins the polymer-containing solution directly onto the conductive layer. The polymer-containing solution and process that are most suitable are those described in U.S. Pat. No. 8,518,319, assigned to Nanostatics Corporation, which is incorporated by reference in its entirety, (hereinafter referred to as the “solution spun process” or “solution spun nanofibers”). Polymers that are suitable for use in the nanofiber layer 10 according to an embodiment are non-polar, non-conductive thermoplastic polymers. Examples of such thermoplastic polymers include but are not limited to polystyrene, styrene butadiene, other aromatic side chain polymers, polymethylmethacrylate (PMMA) or other acrylate polymers, polyvinylchloride (PVC), other non-polar or non-conductive polymers, or copolymers or derivatives or combinations thereof. In an embodiment, a single thermoplastic polymer, or monopolymer, is utilized to form the nanofiber layer 10.

One example of polymer-containing solution that exhibits reduced conductivity is a mixture of (i) a solution of polystyrene (PS) in D-limonene (DL) and (ii) an inorganic salt dissolved in dimethyl formamide (DMF). Polystyrene is a non-polar, non-conductive polymer; D-limonene is a relatively high-boiling, low vapor pressure, non-polar solvent that occurs naturally in citrus rinds. D-limonene is attractive as a “green,” or environmentally friendly, organic solvent, and is readily available in large quantities as a byproduct of citrus processing.

The solution spun nanofibers 12 disclosed above were formed using a conventional electrospinning apparatus and the modified process/fluids described above, in which a conduction path was established between the polymer-containing solution and an electrode. In a conventional electrospinning apparatus, however, a conductive screen/plate/grid/mesh serves as the conductive target to maintain the conductive pathway. It was found, however, that attempts to form or otherwise deposit the nanofibers onto a non-conductive layer positioned upon the conductive target, at loadings useful in high efficiency filtration applications (that is, applications requiring an efficiency removal of MERV 14-16, or even higher efficiencies), was simply not possible. In fact, many of the nanofibers would fly right over the surface of the non-conductive layer trying to find ground in surrounding metallic components of the processing machinery. The nanofibers were literally moving sideways rather than going downwards to lay upon the surface of the non-conductive layer.

According to an aspect, the electrospinning apparatus produced an electric field that guided the polymer-containing solution that was extruded from a spinning head assembly to the conductive layer 20, which served as the electrode. Typically, the spinning head assembly includes an array of the nozzles through which the solution is extruded.

While use of a certain deposition rate and/or loading is desirable of the nanofibers 12 upon the conductive layer 20, it should be readily understood that it is difficult to actually measure the resulting so-called “layer” of nanofibers 12. In practice, even at the higher loadings desirable in the composite filtration media 100 described herein, that is, nanofiber layers having a basis weight of about 0.5 to about 2.0 gsm, the nanofiber layer 10 is not a “layer” as much as a coating formed upon the conductive layer 20. In fact, visually, the nanofiber layer 10 appears as a dust upon the conductive layer 20. The nanofibers 12 or nanofiber layer 10 require no additional bonding or adhesive in order to adhere or attach to the conductive layer 20.

Thus, to measure the loading or basis weight of the nanofiber layer 10 upon the conductive layer 20, one can only measure the amount of material (or nanofibers 12) extruded from the solution spinning process, rather than actually measure the weight of the nanofiber layer 10 itself. Thus, knowing the parameters of the solution spinning process (e.g. pressure, time, start and finish weights, solution flow, % solids, nozzle width, line speed, area covered, number of nozzles, flow rate per nozzle, and the like), will help determine the actual basis weight of the nanofiber layer 10. Alternatively, the basis weight of the composite filter medias 100 can be determined, and once the basis weight of the conductive layer 20 is known, then the basis weight of the nanofiber layer 10 can be calculated.

While nanofiber layers 10 having a basis weight of about 0.5 to about 2.0 gsm are considered particularly useful, and not possible to make without the conductive layer and solution spinning process described herein, higher basis weights are even more desirable because they provide a more robust media without compromising the efficiency of the composite filter media 100. Thus, nanofiber layers 10 having a basis weight of greater than about 0.6 up to about 2.0 gsm are even more desirable. It is also contemplated that the although nanofibers having a diameter up to about 1000 nm are capable of being made, it was found that nanofibers having a diameter of about 300 to about 800 nm are particularly useful because finer fibers cause less disruption to air flow to the media resulting in a lower pressure drop across the media at any design specified airflow. This also results in an improved alpha.

As an aside, although it is recognized that the terms “microfiber” and “nanofiber” may overlap in diameter size, as used herein, the term “microfibers” include fibers made using currently available commercial meltblown machinery, which is typically not capable of making microfibers have less than about 800 nm in diameter given current technology having a diameter greater than about 800 nm

Turning to FIG. 2, an alternative composite filter medias 100 according to an embodiment is provided in which an optional and additional one or more nonwoven layer(s), or prefilter layer(s) 40, is attached to the nanofiber layer 10. As shown in FIG. 2, an additional adhesive layer 30 may be provided to effect attachment of the one or more prefilter layers 40 to the nanofiber layer 10. The prefilter layer 40 functions, when used, to essentially hold the nanofiber layer 10 in place, and to keep it from separating from the conductive layer 20. The prefilter layer 40 may also function as an upstream layer to remove larger particles from the fluid stream prior to engagement with the nanofiber layer 10. As shown herein, the adhesive layer 30 is positioned between the nanofiber layer 10 and the prefilter layer 40.

The prefilter layer 40 may include a meltblown layer in an embodiment, and in yet a further embodiment, the prefilter layer 40 may include an electrically charged meltblown layer. If the prefilter layer 40 is formed as a meltblown nonwoven material, the microfibers 12 that form the layer 40 will typically have an average diameter of about 1 to about 25 μm. In an embodiment, the prefilter layer 40 has a basis weight of about 5 to about 60 gsm. The prefilter layer 40 may be formed from any known synthetic polymer. Examples of such useful polymers include but are not limited to one or more of polyester, nylon, acrylic, modacrylic, and polyolefin. More specifically, the synthetic polymeric fiber may be made from the following polymers: polylactide (PLA), polyethylene, polypropylene, polyethylene terephthalate (PET), aliphatic polyamides (Nylon) and/or polybutylene terphthalate (PBT). It is also contemplated that the prefilter layer 40 may include other additives and/or natural fibers, such as glass, cotton, cellulose, and the like. In addition, the prefilter layer 40 may have a Frazier of about 10 to about 1000 cubic feet per minute (cfm).

According to an aspect, the composite filter medias 100 is anti-oxidant free. The reason that anti-oxidants are not particularly useful in the media described herein is the grounding potential of the conductive layer 20 can be buffered, thus rendering it less effective for charge dissipation during the nanofiber deposition or solution spinning process.

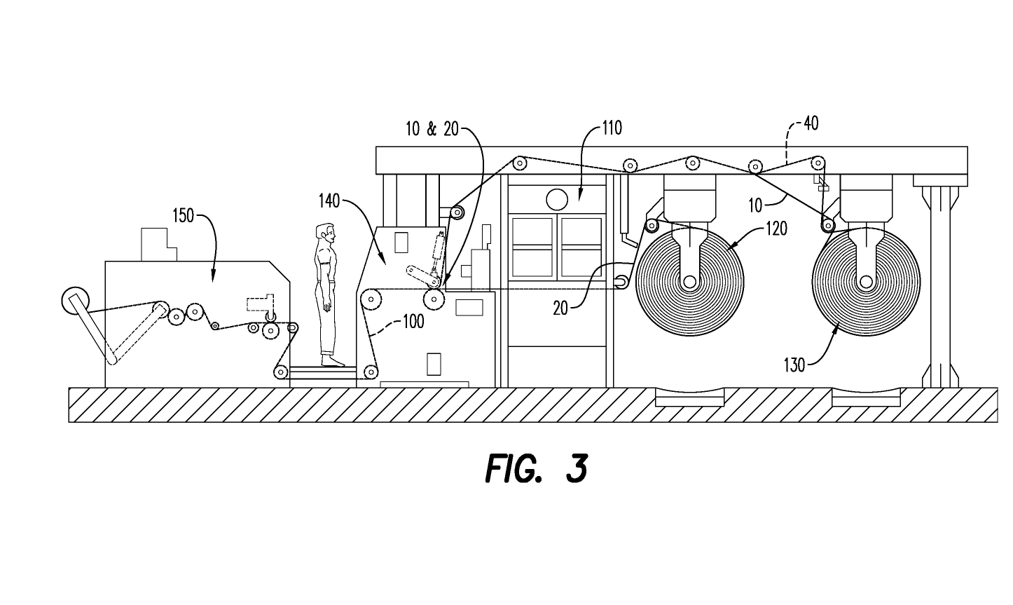

FIG. 3 is a schematic representation of a typical process wherein the solution spun nanofiber layer 10 is formed using a solution spinning process (not specifically shown), such that the nanofibers 12 (see FIG. 1) are formed directly onto the conductive layer 20. As shown herein, the conductive layer 20 was pre-made onto a roll, 120, and then fed through the process towards the nanofiber forming process 110. At the exit of the nanofiber forming process 110, the composite filter medias 100 (at this stage only including the nanofiber layer 10 and the conductive layer 20), enters into a lamination process 140, where the optional prefilter layer 130 and adhesive layer are added. Finally, the composite filter medias 100 is finished in a finishing process 150.

After formation, the composite filter media can be further processed according to a variety of known techniques. For example, the composite filter media can be pleated and used in a pleated filter element. In one aspect, composite filter media, or various layers thereof, can be suitably pleated by forming score lines at appropriately spaced distances apart from one another, allowing the composite filter media to be folded. It should be appreciated that any suitable pleating technique can be used.

The composite filter media can include other parts, including one or more structural features and/or stiffening elements, such as polymeric and/or metallic meshes. For example, a screen backing can be disposed on the composite filter media, providing for further stiffness. Yet in another aspect, a screen backing can aid in retaining the pleated configuration. For example, a screen backing can be an expanded metal wire or an extruded plastic mesh.

The composite filter media can be incorporated into a variety of suitable filter elements for use in various applications including ASHRAE filter media applications. The composite filter media can be used for any air or liquid filtration application. As an example, the composite filter media can be used in heating and air conditioning ducts. The composite filter media also can be used in combination with other filters as a pre-filter, such as for example, acting as a pre-filter for high efficiency filter applications (e.g., HEPA). Filter elements can have any suitable configuration as known in the art including bag filters (typically un-pleated) and panel filters (typically pleated).

In one aspect, the filter element includes a housing that can be disposed around the composite filter media. The housing can have various configurations, with the configurations varying based on the intended application. In another aspect, the housing can be formed of a frame that is disposed around the perimeter of the composite filter media. For example, the frame can be thermally sealed around the perimeter. Yet in another aspect, the frame has a generally rectangular configuration surrounding all four sides of a generally rectangular filter media. The frame can be formed from various materials, including for example, cardboard, metal, polymers, or any combination of suitable materials. The filter elements can also include a variety of other features known in the art, such as stabilizing features for stabilizing the filter media relative to the frame, spacers, or any other appropriate feature.

The composite filter media can be incorporated into a bag (or pocket) filter element. A bag filter element can be formed by placing two filter media together (or folding a single filter media in half), and mating three sides (or two if folded) to one another such that only one side remains open, thereby forming a pocket inside the filter. In one aspect, multiple filter pockets can be attached to a frame to form a filter element. Each pocket can be positioned such that the open end is located in the frame, thus allowing for air flow into each pocket. In another aspect, a frame can include rectangular rings that extend into and retain each pocket. It should be appreciated that a frame can have virtually any configuration, and various mating techniques known in the art can be used to couple the pockets to the frame. Moreover, the frame can include any number of pockets, such as for example, between 6 and 10 pockets, which are common for bag filters.

A bag filter can include any number of spacers disposed therein and configured to retain opposed sidewalls of the filter at a spaced distance apart from one another. Spacers can be threads or any other element extending between sidewalls. It can be understood that various features known in the art for use with bag or pocket filters can be incorporated into the composite filter media disclosed herein.

It should be understood that the composite filter media and filter elements can have a variety of different constructions and the particular construction depends on the application in which the composite filter media and elements are used. In some aspects, an additional substrate or membrane can be added to the composite filter media. The filter elements can have the same property values as those noted above in connection with the composite filter media.

During use, the composite filter media mechanically trap contaminant particles on the fiber web as fluid (e.g., air or liquid) flows through the filter media. In some applications, it is desirable that sub-micron particles (that is, particles having a size less than 1 micron) are removed from an air stream at particularly high efficiency levels. As referenced hereinabove, the composite filter media described herein are capable of achieving MERV rates of 14 or higher, 15 or higher, or even 16. As would be understood by one of ordinary skill in the art, ASHRAE Standard 52.2-1999 (“ASHRAE 52.2”) sets out the parameters by which the composites are tested, and provides a MERV rating (on a scale of 1-16) based on the ability of the filtration media to remove varying sized particles as partially set forth in Table 1:

TABLE 1

| | Composite Average Particle Size Efficiency | | |
|---|---|---|---|
| | % in Size Range, μm | | |
| MERV | Range 1 - 0.30-1.0 | Range 2 - 1.0-3.0 | Range 3 - 3.0-10.0 |
| 13 | N/A | E2 ≧ 90 | E3 ≧ 90 |
| 14 | E1 ≧ 75 | E2 ≧ 90 | E3 ≧ 90 |
| 15 | E1 ≧ 85 | E2 ≧ 90 | E3 ≧ 90 |
| 16 | E1 ≧ 95 | E2 ≧ 95 | E3 ≧ 95 |

In other words, for a composite filter media to qualify at a filtration efficiency of MERV 16, it must be capable of removing E1 particles (particles having a size range of 0.30-1.0 E2 particles (1.0-3.0 tm sized particles) and E3 particles (3.0-10.0 tm sized particles), all at 95% or greater efficiency. In addition, it is possible to subject the filtration media to even finer standards, and according to Appendix J of ASHRAE 52.2, the filtration media may be subjected to additional conditioning steps to mimic real-life filter efficiency degradation, in which potassium chloride (KCL) is aerosolized using a strict protocol and introduced to the filter media, resulting in discharging the media. Yet another example is the European standard EN 779, which uses isopropyl alcohol to discharge the media.

The composite filter media need not be electrically charged to enhance trapping of contamination. Thus, in some aspects, the composite filter media are not electrically charged. However, in other aspects, the composite filter media can be electrically charged. In a particularly desirable application, the composite filter media described herein are specifically discharged.

The composite filter media of the present disclosure can have many applications, not limited to ASHRAE applications. For example, the composite filter media can be suitable for liquid-liquid coalescing applications, gas-liquid coalescing applications, hydraulic filtering applications, and the like. It is to be understood that the uses and applications of the media disclosed herein are not limited, and any suitable application of the composite filter media is possible.

### EXAMPLES

Samples of the composite filter medias 100 according to an embodiment were prepared in which a wet-laid nonwoven conductive layer 20 was made using 75 wt. % polyethylene terephthalate staple fibers of about 6.0 denier and/or 25.0 micron fiber diameter, and 12 to 24 mm lengths, 7.0+ wt. % carbon fibers of about 0.7 denier and/or 7.5 micron fiber diameter, and about 6.0 mm length, and 19 wt. % acrylic-styrene copolymer binder. The conductive layer 20 was made using an inclined wire wet laid process, as would be understood by one of ordinary skill in the art, and with a typical drying and curing oven to complete the forming system. The conductive layer 20 had a basis weight of 51 gsm, a thickness of about 0.007 inches, a stiffness of about 500 mg, an alpha of about <10, and a surface conductivity of 10⁻⁷ microsiemens. The nanofiber layer 10 was made from solution spun polystyrene fibers having a diameter of about 300 nm using the solution spun process described hereinabove and was formed directly onto the wet-laid nonwoven conductive layer 20. The nanofiber layer 10 had a calculated basis weight as set forth in Table 2 below and a thickness estimated to be about 500 nm. Finally a highly charged (e.g. using a multi-beam corona charged) prefilter layer 40, in this instance, a meltblown layer, made of 100 wt. % polypropylene fibers having a charge of between about 0 and 150 kV, an average diameter of about 2-3 micron and a basis weight of about 33 gsm was attached to the nanofiber layer 10, using a sprayed-on fiberized pressure-sensitive adhesive layer 30, known as PSA, which is commercially available from HB Fuller. The adhesive layer 30 had a basis weight of <2 gsm. The meltblown layer 40 had a stiffness of <100 mg, a thickness of 0.025 in., and an alpha >50 charged.

The sample marked as “Control” was a sample without the nanofiber layer 10. The composite filter media (samples F, A, B2 and D) as well as the Control sample were subjected to various tests, and the results of the tests are presented in Tables 2 and 3. Various terms are used in Table 2, and are defined as follows: “Deposition” refers to the calculated basis weight of the nanofiber layer 10 based on various parameters of the solution spinning process such as number of nozzles, flow rate, and the like as described hereinabove; “Flow” is the solution spun process setting in which air pressure is applied to the nozzles and is a “measure” of the amount of solution coming out of the nozzles; “Speed” refers to the line speed at which the conductive layer 20 is moving as the nanofiber layer 10 is deposited thereon (the goal was to achieve at least about 50 to about 100 feet per minute (fpm) as these speeds would likely be a desirable commercially acceptable speeds); “I.R.” refers to the Initial Resistance of the media before it was discharged in inches of water column; “mm” refers the Initial Resistance in millimeters of water column, WG; “Resistance (Pa)” is as defined hereinabove, and “Frazier” refers to the Frazier as defined hereinabove. The test results are presented in Table 3 as particle removal efficiencies for each of E1, E2 and E3, both before any charge is removed from the composite filter media, as well as after discharge. As expected, the Frazier is impacted downwardly as the deposition (loading) of nanofibers upon the conductive layer increases, since the addition of these finer nanofibers provides for more efficient filtration.

TABLE 2

| | | | | | | Resistance (Pa) | | | |
|---|---|---|---|---|---|---|---|---|---|
| | Deposition | Flow | Speed | I.R. | mm | BHT | 8130 | 8127 | Frazier |
| Control | 0.00 | 0.0 | 0 | 0.08 | 2.0 | 20.3 | 27.4 | 27.4 | 89.3 |
| F | 0.17 | 7.5 | 100 | 0.12 | 3.1 | 30.5 | 31.4 | 33 | 60.0 |
| A | 0.54 | 5.0 | 25 | 0.13 | 3.3 | 33.1 | 36.9 | 39.5 | 57.5 |
| B2 | 0.70 | 7.5 | 25 | 0.17 | 4.3 | 43.4 | 43.8 | 50.6 | 47.9 |
| D | 1.17 | 7.5 | 15 | 0.19 | 4.8 | 48.3 | 50 | 56.2 | 34.3 |

The test results are presented in Table 3 as particle removal efficiencies according to ASHRAE 52.2 for each of E1, E2 and E3, both before any charge is removed from the composite filter media, as well as after discharge (according to Appendix J.

TABLE 3

| | Charged | | | | | Discharged | | | | |
|---|---|---|---|---|---|---|---|---|---|---|
| | E1 | E2 | E3 | | MERV | E1 | E2 | E3 | | MERV |
| Control | 88 | 97 | 100 | 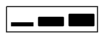 | 15 | 54 | 78 | 98 | 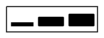 | 11 |
| F | 96 | 100 | 100 | 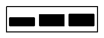 | 16 | 93 | 99 | 100 | 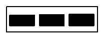 | 15 |
| A | 96 | 100 | 100 | 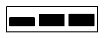 | 16 | 93 | 99 | 100 | 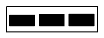 | 15 |
| B2 | 96 | 100 | 100 | 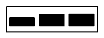 | 16 | 96 | 100 | 100 | 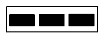 | 16 |
| D | 96 | 100 | 100 | 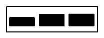 | 16 | 96 | 100 | 100 | 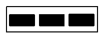 | 16 |

As can be seen from the data, at lower loadings of nanofiber layer, (Examples F and A with a basis weight of 0.54 gsm and under), it is not possible to achieve MERV 16 ratings for a discharged composite filter media. As set forth hereinabove, it is simply not possible to achieve nanofiber layer loading in excess of 0.35 gsm, 0.5 gsm, or greater than 0.6 gsm without use of the conductive layer and the solution spinning process described herein.

The media and methods illustrated are not limited to the specific embodiments described herein, but rather, features illustrated or described as part of one embodiment can be used on or in conjunction with other embodiments to yield yet a further embodiment. It is intended that the media and method include such modifications and variations. Further, steps described in the method may be utilized independently and separately from other steps described herein.

While the media and method have been described with reference to specific embodiments, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the media and method, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A composite filter media, comprising:
a porous, wetlaid, conductive layer comprising greater than at least about 5 wt. % conductive fibers mixed into a matrix to form the conductive layer, the conductive layer having Z-directional conductivity, a uniform surface conductivity of at least about 10⁻⁷ microsiemens, a basis weight of about 10-200 gsm, and a Frazier of about 200-1000 cubic feet per minute (cfm);
a nanofiber layer comprising solution spun nanofibers formed from non-polar, non-conductive thermoplastic polymers, the nanofiber layer having a basis weight of about 0.5-2.0 gsm and an average fiber diameter of about 300-800 nm, wherein the nanofiber layer is formed directly onto the conductive layer;
one or more optional prefilter layer(s) having a basis weight of about 5-60 gsm; and
an optional adhesive layer between the nanofiber layer and the prefilter layer.

2. The composite filter media of claim 1, wherein the conductive layer further comprises synthetic fibers.

3. The composite filter media of claim 2, wherein the synthetic fibers comprise one or more polymeric fibers selected from the group consisting of polylactide (PLA), polyethylene, polypropylene, polyethylene terephthalate (PET), aliphatic polyamides (Nylon) and polybutylene terphthalate (PBT).

4. The composite filter media of claim 1, wherein the conductive layer is a self-supporting, pleatable substrate.

5. The composite filter media of claim 1, wherein the conductive fibers comprise carbon fibers.

6. The composite filter media of claim 1, wherein the nanofiber layer comprises nanofibers made of a single thermoplastic polymer.

7. The composite filter media of claim 6, wherein the single thermoplastic polymer is selected from the group consisting of polystyrene, styrene butadiene, polymethylmethacrylate (PMMA) and polyvinylchloride (PVC).

8. The composite filter media of claim 1, wherein the nanofiber layer comprising a basis weight of greater than about 0.6-2.0 gsm.

9. The composite filter media of claim 1, wherein the composite filter media is anti-oxidant free.

10. The composite filter media of claim 1, wherein the prefilter layer is a meltblown layer.

11. The composite filter media of claim 1, wherein the prefilter layer is an electrically charged meltblown layer.

12. The composite filter media of claim 1, wherein the prefilter layer has a Frazier of about 10-1000 cfm and comprises polypropylene microfibers having a diameter of about 1 to 25 um.

13. A method of making a composite filter media comprising:
providing a porous, wetlaid, conductive layer, the conductive layer comprising greater than at least about 5 wt. % conductive fibers mixed into a matrix to form the conductive layer, the conductive layer having Z-directional conductivity, a uniform surface conductivity of at least about 10⁻⁷ microsiemens, a basis weight of about 10-200 gsm, and a Frazier of about 200-1000 cubic feet per minute (cfm); and
solution spinning nanofibers directly onto the conductive layer, thereby forming a nanofiber layer, wherein the nanofibers are formed from non-polar, non-conductive thermoplastic polymers, and wherein the nanofiber layer has a basis weight of about 0.5-2.0 gsm and an average fiber diameter of about 300-800 nm.

14. The method of claim 13, further comprising:
adding one or more prefilter layer(s) having a basis weight of about 5-60 gsm to the composite filter media.

15. The method of claim 13, further comprising:
adding an adhesive layer between the nanofiber layer and the prefilter layer.

16. The method of claim 13, wherein the conductive layer further comprises synthetic fibers, the synthetic fibers comprising one or more polymeric fibers selected from the group consisting of polylactide (PLA), polyethylene, polypropylene, polyethylene terephthalate (PET), aliphatic polyamides (Nylon) and polybutylene terphthalate (PBT).

17. The method of claim 13, further comprising:
pleating the composite filter media to form a pleated filter element.

18. The method of claim 13, wherein the conductive fibers comprise carbon fibers.

19. The method of claim 13, wherein the nanofiber layer comprises nanofibers made of a single thermoplastic polymer, and the single thermoplastic polymer is selected from the group consisting of polystyrene, styrene butadiene, polymethylmethacrylate (PMMA) and polyvinylchloride (PVC).

20. The method of claim 13, wherein the nanofiber layer comprising a basis weight of greater than about 0.6-2.0 gsm.
